(19) United States
(12) Patent Application Publication
(10) Pub. No.: US 2009/0298584 A1
(43) Pub. Date: Dec. 3, 2009

(54) APPARATUS FOR GAMING MACHINE

(76) Inventors: George Hoehne, St. Charles, IL (US); James Cove, Blakeshall (GB)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/127,249

(22) Filed: May 27, 2008

(51) Int. Cl. A63F 13/00

(52) U.S. Cl. 463/31

(57) ABSTRACT

A gaming machine includes a base, a variable display supported by the base, a navigation device, and at least one switch. The variable display variably and/or graphically presents a game to a user, and the variable display variably and/or graphically presents game related options to the user. The navigation device, such as a trackball, is supported by the base, and the navigation device permits the user to navigate through the game related options so that the user can designate at least one of the game related options. The switch is supported by the base, and the switch is operable by the user to activate the designated game related option.

### TECHNICAL FIELD

Disclosed herein is an apparatus for a gaming machine where the apparatus includes a navigation device, such as a trackball, a lever (e.g., joy stick), or a pad, that permits a user to navigate through game related options offered by a host gaming machine.

### BACKGROUND

Current gaming machines such as those provided by arcades and casinos rely upon button actuated switches to select game related options such as those that advance the play of a game. The number of button actuated switches on such machines depends upon the number of game related options available to the players during the play of the games, with more complex play requiring more options and, therefore, more button actuated switches. Thus, as games offered by gaming machines increase in complexity, the number of button actuated switches increases commensurately, which increases the size of the panel that is used to mount the button actuated switches to the machines.

As the size of the button actuated switch panel on a gaming machine increases, the machine becomes more expensive to build and more difficult to use. Also, as the sizes of gaming machines increase to accommodate larger numbers of button actuated switches, fewer machines can be offered by arcades and casinos having limited spaces in which the offer the machines, thus reducing revenues because of the space related constraint on the number of machines that can be played at any one time.

Various schemes have been proposed to reduce the area required to mount the button actuated switches to a gaming machine while at the same time offering more complex games to users. For example, it has been suggested to mount the button actuated switches in a geographically compact manner. Such a mounting arrangement, however, results in a button actuated switch topography that is difficult for users to manage.

It has also been suggested to interface the button actuated switches with a controller such that functions of the button actuated switches can be changes as a game progresses. Thus, fewer button actuated switches can be used to perform increasing numbers of functions. Again, however, such button actuated switches can be difficult to use.

The navigation device disclosed herein solves one or more of these or other problems.

### BRIEF DESCRIPTION OF THE DRAWING

Features and advantages of the navigation device disclosed herein will become more apparent from the following detailed description when taken in conjunction with the drawing in which:

FIG. 1 is schematic of a controller having examples of inputs and arranged to control a host gaming machine;

FIG. 2 is top view of a panel that can be attached to the host gaming machine and that has a pair of button actuated switches and a navigation device shown by way of example as a trackball;

FIG. 3 is top view of an alternative panel that can be attached to the host gaming machine and that has a single button actuated switch and a navigation device shown by way of example as a trackball;

FIGS. 4 and 5 offer top and side views of a further alternative panel that can be attached to the host gaming machine and that has a single switch operated by depression of a navigation device shown by way of example as a trackball;

FIG. 6 illustrates an example of a host gaming machine;

FIG. 7 is an exploded view of a navigation device provided with backlighting;

FIG. 8 illustrates a separate display for displaying the navigation of a navigation device; and,

FIG. 9 is a flow chart of part of a program that can be executed by the processor of FIG. 1.

### DETAILED DESCRIPTION

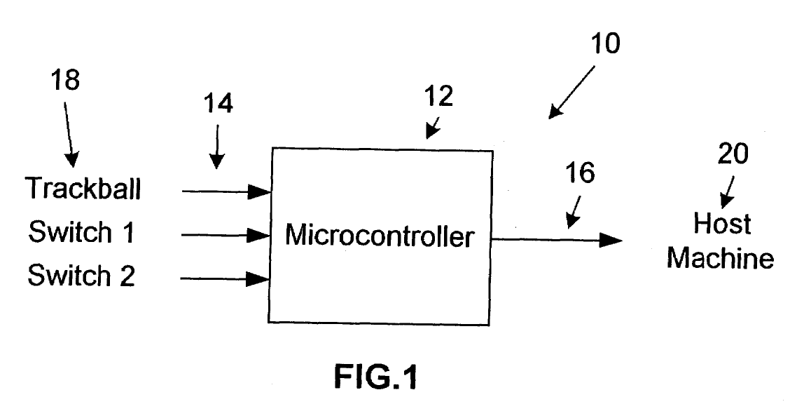

A gaming machine navigation system 10 is shown in FIG. 1 and includes a processor 12 such as a microcomputer having an input interface 14 and an output interface 16. The input interface 14 directs signals from various user input devices 18, such as a navigation device, which may be, for example, in the form of a trackball, and one or more switches such as button actuated switches, to the processor 12. The output interface 16 supplies signals from the processor 12 to various display and/or other output components of a host gaming machine 20, and/or the output interface 16 directs signals from various display and/or other output components of the host gaming machine 20 to the processor 12.

The processor 12 interprets inputs from the input devices 18 and passes these inputs on to the processing equipment such as a computer of the host gaming machine 20. In this case, the processor 12, the input interface 14, the output interface 16, and/or the input devices 18 are supported by a panel 22 that is then mounted to the host gaming machine 20.

Alternatively, the processor 12, the input interface 14, the output interface 16, and/or the input devices 18 may be supported by other components of the host gaming machine 20. The processing equipment of the host gaming machine 20 is housed elsewhere by the host gaming machine 20.

As a further alternative, the functions of the processor 12 can be combined with the processing equipment of the host gaming machine 20 such that the host gaming machine 20 has a single processor to perform all of its functions.

As a still further alternative, the processor 12, the input interface 14, the output interface 16, and/or the input devices 18 are supported by the panel 22 of the host gaming machine 20 and the remainder of the processing equipment of the host gaming machine 20 may be housed remotely from the host gaming machine 20.

As a yet further alternative, all processing capability for the host gaming machine 20 including the processing capability of the processor 12 can be provided remotely from the host gaming machine 20.

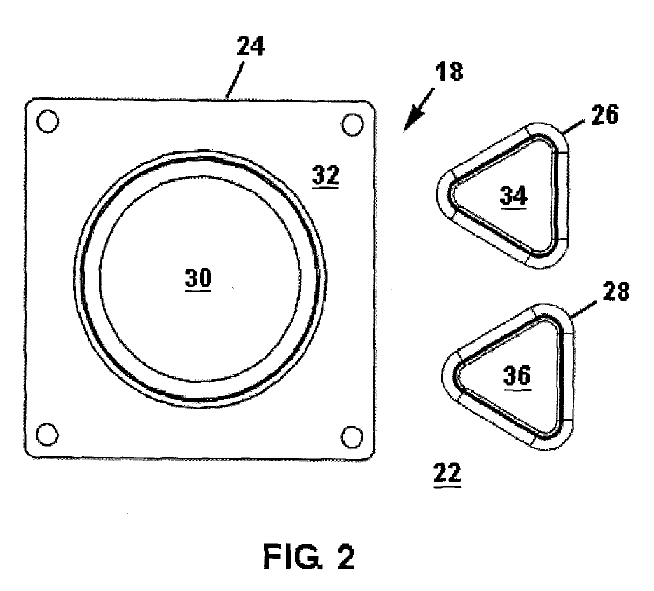

The input devices 18 of the gaming machine navigation system 10 may be arranged on the panel 22 as shown in FIG. 2. The panel 22 may be part of the host gaming machine 20 as indicated herein. As shown in FIG. 2, the input devices 18 include a navigation device 24 and first and second button actuated switches 26 and 28.

As particularly shown in FIG. 2, the navigation device 24 is a trackball 30 suitably and conventionally supported by a support structure 32 for rotation in any direction. Rotation of the trackball 30 causes suitable x-y coordinate signals to be sent from the trackball 30 to the processor 12 as is known. The processor 12 decodes these x-y coordinate signals in any known manner so as to control the position of a navigation designator that is used to designate text or a graphic currently selected by the user. A pointer or other cursor may be used as the navigation designator controlled by the navigation device so as to point to or otherwise designate a user selected game related option in the form of text or a graphic. Alternatively, highlighting may be used as the navigation designator controlled by the navigation device so as to highlight a user selected game related option in the form of text or a graphic. As a further alternative, making a game related option visible (or not) may be used as the navigation designator controlled by the navigation device.

However, the navigation device 24 could be a device other than a trackball such as a lever or a pad. The lever might be similar to a joy stick, and the pad might be similar to a mouse pad.

The support structure 32 can be mounted to the panel 22 as a separate piece from the panel 22, or the support structure 32 may instead be integrally formed as a part of the panel 22. In this latter case, the support structure 32 and the panel 22 may be coplanar or not as desired.

The first button actuated switch 26 includes a button 34 that, when depressed, operates a corresponding switch (not shown) to perform one or more functions. Similarly, the second button actuated switch 28 includes a button 36 that, when depressed, operates a corresponding switch (also not shown) to perform one or more functions. For example, the first button actuated switch 26 may be operated to select a mode of operation of the host gaming machine 20, and the first button actuated switch 26 may be operated to activate or choose a game related option designated by the navigation device 24.

Further to this example, the first button actuated switch 26 may be operated by the user to indicate that the user wants to select the credits to be wagered. The user operates the navigation device 24 to navigate among the various displayed amounts of credits. In this connection, as the navigation device 24 is operated by the user, the designator described above is moved by navigation device 24 operated by the user until the designator designates which of the displayed amounts of credits the user chooses to wager. When the navigation device 24 has been operated so that the designator designates the desired displayed amount of credits, the user operates the first button actuated switch 26 to choose that amount.

Still further to this example, the first button actuated switch 26 may be operated again by the user to indicate that the user wants to select a number of lines to play. The user operates the navigation device 24 to navigate among the various displayed line combinations. When the navigation device 24 has been operated so that the designator designates the displayed line combination desired by the user, the user operates the first button actuated switch 26 to choose that desired line combination.

The navigation device 24 and/or the first and second button actuated switches 26 and 28 may be programmed to perform additional and/or other functions, as desired.

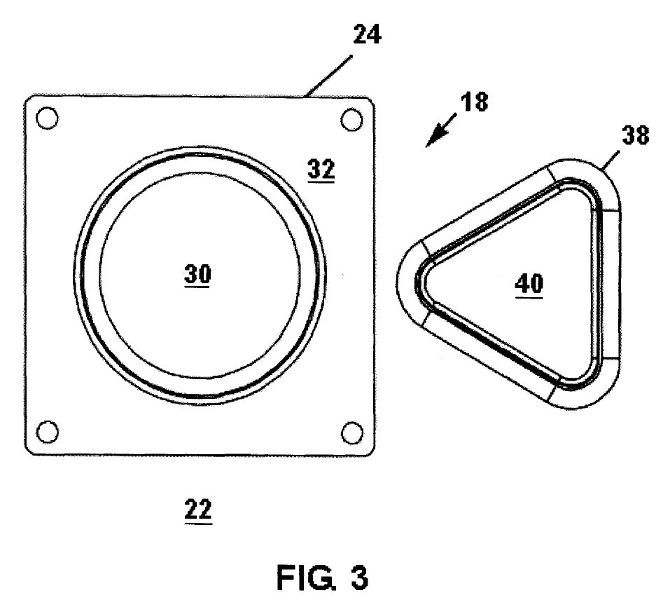

According to an alternative embodiment shown in FIG. 3, the input devices 18 include the navigation device 24 and only one button actuated switch, i.e., a button actuated switch 38. The input devices 18 of the gaming machine navigation system 10 may be arranged on the panel 22. As particularly shown in FIG. 3, the navigation device 24 is the trackball 30 suitably and conventionally held to the support structure 32 in any of the manners described above. Also as before, instead of the trackball 30, the navigation device 24 can be another device such as a lever or a pad.

The button actuated switch 38 includes a button 40 that, when depressed, operates a corresponding switch (not shown) to perform one or more functions. For example, the button actuated switch 38 may be operated to activate a game related option designated by use of the navigation device 24. Further to this example, the user operates the navigation device 24 to navigate the designator among various amounts of credits that can be wagered. When the navigation device 24 has been operated so that the designator designates an amount of credits that the user desires to wager, the user operates the button actuated switch 38 to activate or choose the designated amount of credits. Then, the user operates the navigation device 24 to navigate the designator among various line combinations. When the navigation device 24 has been operated so that the designator designates a line combination desired by the user, the user operates the button actuated switch 38 to activate or choose that the designated line combination.

The navigation device 24 and/or the button actuated switch 38 may be programmed to perform additional and/or other functions, as desired.

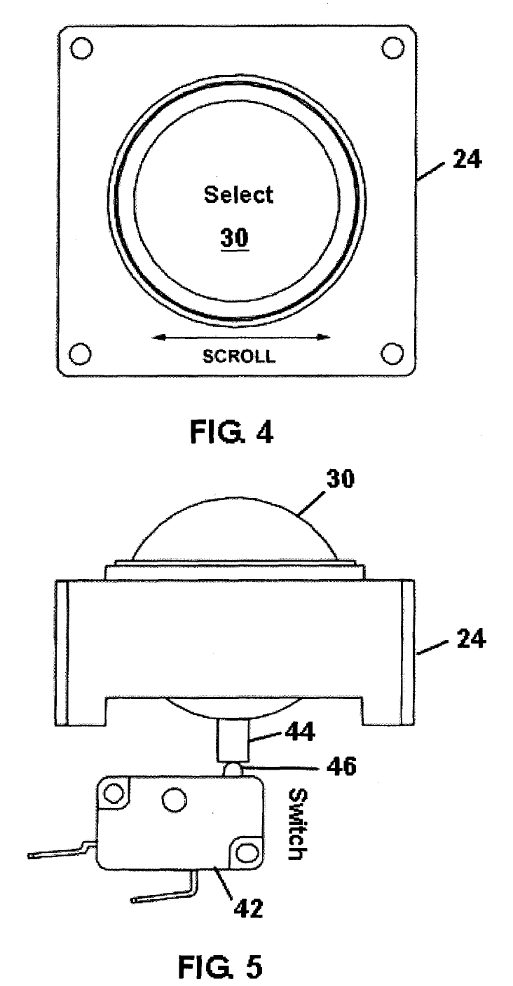

According to another alternative embodiment shown in FIGS. 4 and 5, the separate button actuated switches described above may be replaced by a switch 42. The switch 42 may be considered an element of the input devices 18 and is operated directly by the navigation device 24. Although a single switch operated directly beneath by the navigation device 24 is shown in FIGS. 4 and 5, it should be understood that the navigation device 24 could be arranged to directly and selectively operate multiple switches. As shown in connection with the embodiment of FIGS. 4 and 5, the switch 42 is located beneath the navigation device 24.

More specifically, the navigation device 24 has the trackball 30 that is held to the support structure 32 in any manner such as those described above so that the trackball 30 may be displaced vertically by a sufficient amount to operate the switch 42. In this connection, the trackball 30 may be spring biased so that it returns to its highest vertical position when released by the user. A switch operator 44 is integrally formed with or attached to the trackball 30 and pushes against a button 46 to either operate the switch 42 so long as the trackball 30 is depressed. Further as before, the navigation device 24 can be another device such as a lever or a pad. (Switches similar to the switch 42 may be used in connection with the button actuated switches 26, 28, and 38.)

The switch 42 operates to perform one or more functions. For example, the switch 42 may be operated by the trackball 30 to choose or activate a game related option designated by the designator controlled by the trackball 30. Further to this example, the user operates the trackball 30 to navigate the designator among various amounts of credits that can be wagered by the user. When the trackball 30 has been operated so that the designator designates an amount of credits that the user desire to wager, the user depresses the trackball 30 to operate the switch 42 so as to choose or activate the designated amount of credit. Then, the user operates the trackball 30 to navigate the designator among various line combinations. When the trackball 30 has been operated so that the designator designates the line combination desired by the user, the user depresses the trackball 30 to operate the switch 42 so as to choose or activate that line combination.

The navigation device 24 and/or the switch 42 may be programmed to perform additional and/or other functions, as desired.

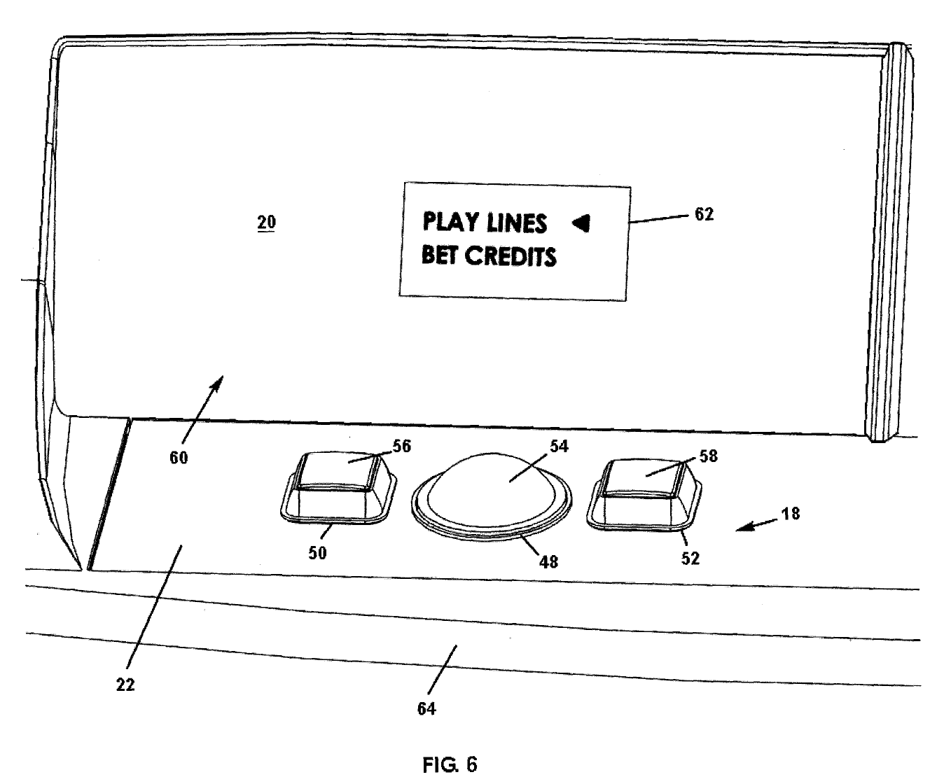

An example of the host gaming machine 20 is shown in FIG. 6. The host gaming machine 20 hosts the gaming machine navigation system 10 and includes the input devices 18 in the form of a navigation device 48 situated between first and second button actuated switches 50 and 52. As particularly shown in FIG. 6, the navigation device 48 is a trackball 54 suitably and conventionally held to the panel 22 for rotation in all directions. As before, rotation of the trackball 54 causes suitable x-y coordinate signals to be sent to the processor 12 for decoding in any known manner. Also as before, the navigation device 48 could be another device such as a lever or a pad. The lever might be similar to a joy stick, and the pad might be similar to a mouse pad.

The first button actuated switch 50 includes a button 56 that, when depressed, operates a corresponding switch (not shown) located beneath the button 56 to perform one or more functions. Similarly, the second button actuated switch 52 includes a button 58 that, when depressed, operates a corresponding switch (also not shown) located beneath the button 58 to perform one or more functions.

The host gaming machine 20 further includes a variable display 60 that variably and/or graphically displays the games and that variably and/or graphically displays various game related options 62 to the user. As shown in FIG. 6, the game related options 62 include a play line option and a bet credit option. However, alternative or additional game related options can be displayed to the user. The user operates the navigation device 48 to move the designator to designate a game related option desired by the user and uses the first and/or second button actuated switches to choose or activate the designated game related option as described above. The user also operates the navigation device 48, the first button actuated switch 50, and/or the second button actuated switch 52 to play the game such as to roll dice, and/or spin reels, and/or other action pertinent to the game selected by the user.

The navigation device 48 and/or the first and second button actuated switches 50 and 52 may be programmed to perform additional and/or other functions, as desired.

The host gaming machine 20 further includes a base 64. The panel 22 and the variable display 60 are suitably attached to the base 64. The base 64 can be arranged with legs and/or with an extended body so that the host gaming machine 20 can rest on the floor with the panel 22 at a height to accommodate a sitting or standing user, as desired. Alternatively, the base 64 can be arranged to support the host gaming machine 20 on a table, stand, or other structure.

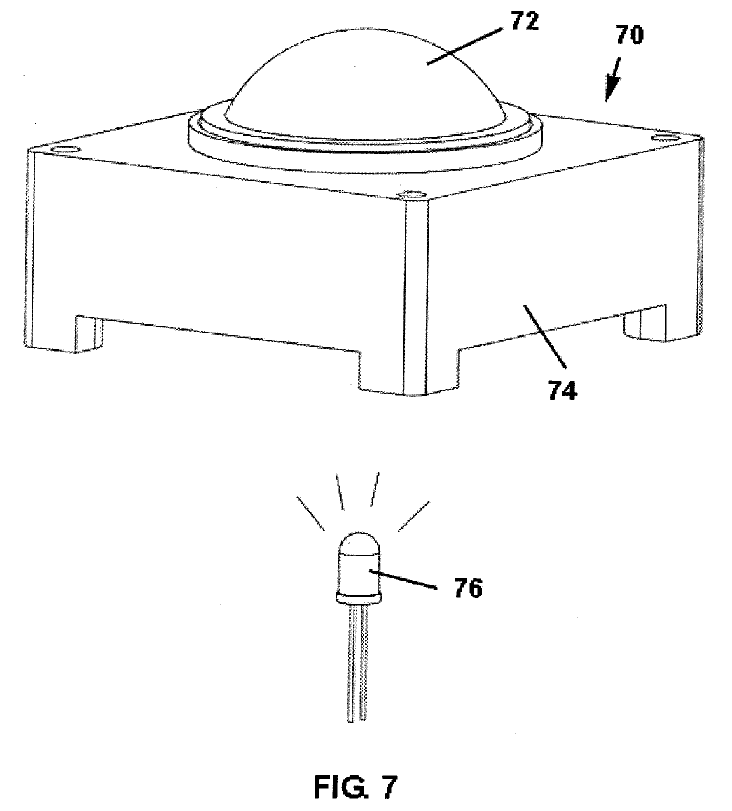

According to another embodiment of the navigation device described herein, a navigation device 70 is illustrated in FIG. 7. As particularly shown in FIG. 7, the navigation device 70 includes a trackball 72 and can be used for any of the navigation devices described above. In the case where the navigation device 70 includes the trackball 72, the trackball 72 is suitably and conventionally held to a support structure 74 for rotation in any and all directions. Rotation of the trackball 72 causes suitable x-y coordinate signals to be sent to the processor 12 for decoding in any known manner. The support structure 74 may be arranged to either mount to the panel 22 or be an integral part of the panel 22 or otherwise. However, the navigation device 70 could be another device such as a lever or a pad. The lever might be similar to a joy stick, and the pad might be similar to a mouse pad.

The trackball 72 is fabricated from any suitable that allows light to pass therethrough, such as a transparent or translucent plastic material. The navigation device 70 further includes a backlight 76. The backlight 76 is located beneath the trackball 72 and is used to illuminate the trackball 72. For example, the backlight 76 may be used to indicate a state, such as an on or off state or an active or inactive state, of the navigation device 70. Additionally or alternatively, the backlight 76 may be used to indicate a function of the navigation device 70. The backlight 76 may be arranged to emit white light or a light of any desired color. Additionally or alternatively, the navigation device 70 may include one or more backlights 76 to illuminate the trackball 72 with different colors. Thus, each of a plurality of different operational states or functions of the navigation device 70 may be indicated by a correspondingly different color.

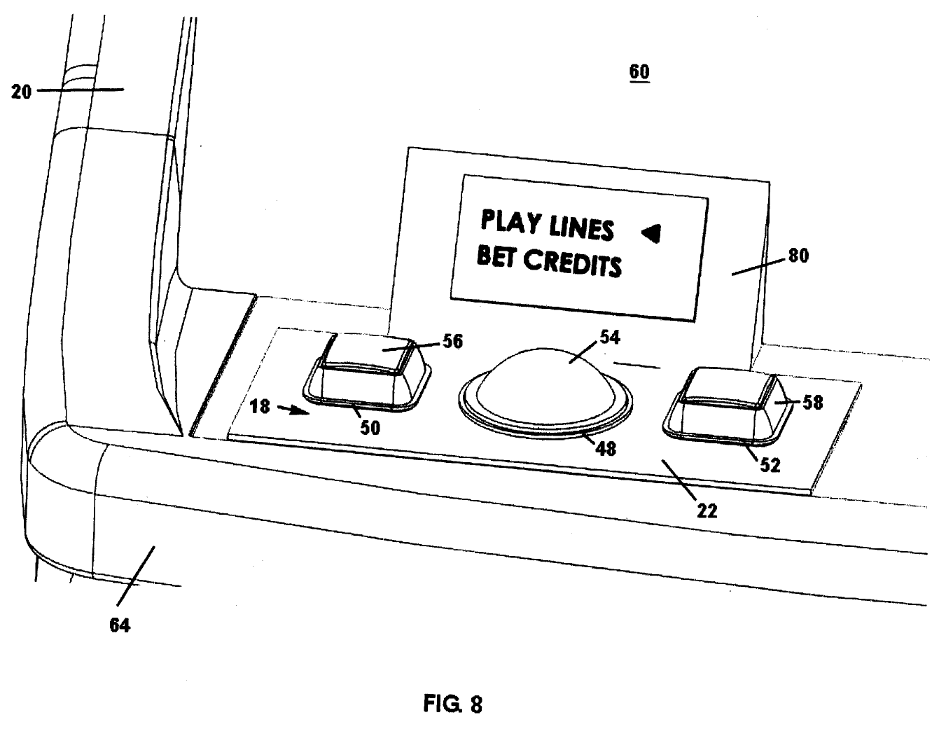

According to another embodiment, a variable display 80 may be provided on the panel 22 of the host gaming machine 20 as shown in FIG. 8. Thus, while the play of a game may be variably and/or graphically presented to the user on the variable display 60 of the host gaming machine 20, some or all of the game related options that may be designated by use of the navigation device may be variably displayed on the variable display 80. Accordingly, the user can navigate (such as by scrolling) the designator through the game related options displayed the variable display 80 by use of the navigation device.

As further shown in FIG. 8, while the variable display 60 is supported directly by the base 64, the variable display 80 is supported by the panel 22 such that the variable display 80 is between the variable display 60 and the user input devices 18.

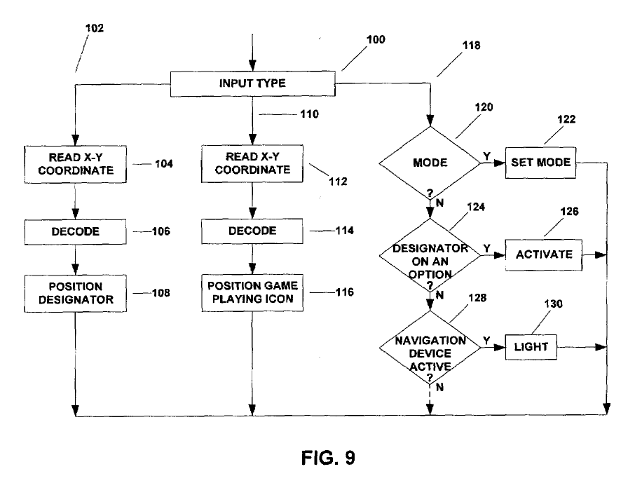

FIG. 9 is a flow chart of part of a program that can be executed by the processor 12. The processor at 100 determines the type of input that it receives.

If the input type is a navigation signal 102 from the navigation device, the processor 12 reads the x-y coordinate signal at 104, decodes the x-y coordinates from the x-y coordinate signal at 106, and positions the navigation designator on the variable display at 108 according to the x-y coordinates. In this manner, the designator can be navigated to a desired game related option as discussed.

If the input type is a control input signal 110 from the navigation device, the processor 12 reads the x-y coordinate signal at 112, decodes the x-y coordinates from the x-y coordinate signal at 114, and positions one or game playing icons (such as a bowling ball, billiard balls, etc.) on the variable display at 116 according to the x-y coordinates. In this manner, the designator can be navigated to a desired game related option as discussed.

If the input type is a signal 118 from a switch, the processor 12 determines whether the signal 118 is a mode selection signal at 120. If the signal 118 is a mode selection signal, the processor 12 at 122 sets the mode of the host gaming machine 20 as appropriate. For example, the mode might be to use the navigation device to designate game related options, the mode might be to use the navigation device as a control input device, etc. If the signal 118 is not a mode selection signal but is a signal to activate a game related option designated by the designator controlled by the navigation device as determined at 124, the processor 12 at 126 activates the designated game related option. If the signal 118 is not a mode selection signal and is not a signal to activate a game related option designated by the designator controlled by the navigation device but is a signal to make the navigation device active as determined at 128, the processor 12 at 130 appropriately controls the backlight 76.

Certain modifications have been discussed above. Other modifications will occur to those practicing in the relevant art. For example, as shown in FIGS. 2 and 3, the button actuated switches are positioned to the right of the navigation device. However, the button actuated switches may be located at any other position with respect to the corresponding navigation device.

Also, the switches operated by the button actuated switches described above may be optical switches, microswitches, magnetic switches, cam switches, etc.

Moreover, as described above, the navigation device is used to navigation (e.g., scroll) a designator through various game related options that can be chosen or activated by a user in connection with the playing of a game. Additionally, the navigation device can be used also as a control input device to control the game itself, such as by guiding a bowling ball or a billiard ball or by spinning reels, etc. For example, any of the switches described above, such as the first button actuated switch 26, can be used to select at least two modes for the navigation device, one where the navigation device is used to navigate the designator through game related options, and one where the navigation device is used as a control input device.

Furthermore, the processor 12 of FIG. 1 may include a port 90 that permits the processor 12 to communicated with another processor of the host gaming machine 20 or with another processor that is remote from the host gaming machine 20.

Accordingly, the description herein is to be construed as illustrative only. The details may be varied substantially without departing from the spirit of the invention as defined by the claims below, and the exclusive use of all modifications which are within the scope of these claims is reserved.

We claim:

1. A gaming machine comprising:
a base;
a variable display attached to the base, wherein the variable display is arranged to variably present a game to a user, and wherein the variable display is also arranged to variably present game related options to the user;
a navigation device attached to the base, wherein the navigation device is arranged to permit the user to navigate through the game related options so that the user can designate at least one of the game related options; and,
a switch attached to the base, wherein the switch is operable by the user to activate the designated game related option.

2. The gaming machine of claim 1 wherein the variable display comprises first and second variable display portions separately supported by the base, wherein the first variable display portion is arranged to variably present the game to the user, and wherein the second variable display portion is arranged to variably present the game related options to the user.

3. The gaming machine of claim 1 wherein the navigation device and the switch are supported by the base such that the switch is actuated by depression of the navigation device.

4. The gaming machine of claim 1 wherein the switch comprises first and second switches, wherein the first switch is operable by the user to activate the designated game related option, and wherein the second switch is operable by the user to select among various modes of operation of the gaming machine.

5. The gaming machine of claim 1 wherein the navigation device comprises a material that permits light to pass through the material at least to some degree, and wherein the gaming machine further comprises a backlight arranged to direct light through the navigation device to be visible by a user.

6. The gaming machine of claim 5 wherein the backlight is selectively energized to selectively indicate whether the navigation device is active.

7. The gaming machine of claim 1 wherein the navigation device comprises a trackball, wherein the trackball is arranged to operate so as navigate a designator through the game related options, and wherein the trackball is arranged to operate as a control input device.

8. The gaming machine of claim 1 further comprising a processor responsive to the navigation device and the switch.

9. The gaming machine of claim 8 wherein the processor is arranged to variably display images on the variable display.

10. The gaming machine of claim 8 wherein the navigation device comprises a trackball, and wherein the processor is arranged to decode position data from the trackball.

11. The gaming machine of claim 8 wherein the processor includes a communication port permitting the processor to communicate with another processor.

12. An apparatus for a gaming machine, wherein the gaming machine has a variable display, wherein the variable display variably presents a game to a user, and wherein the variable display also variably presents game related options to the user, the apparatus comprising:
a base;
a navigation device attached to the base, wherein the navigation device is arranged to permit the user to navigate through the game related options so that the user can designate at least one of the game related options presented on the variable display; and,
a switch attached to the base, wherein the switch is operable by the user to activate the designated game related option.

13. The apparatus of claim 12 wherein the navigation device and the switch are supported by the base such that the switch is actuated by depression of the navigation device.

14. The apparatus of claim 12 wherein the switch comprises first and second switches, wherein the first switch is operable by the user to activate the designated game related option, and wherein the second switch is operable by the user to select among various modes of operation.

15. The apparatus of claim 12 wherein the navigation device comprises a material that permits light to pass through the material at least to some degree, and wherein the apparatus further comprises a backlight arranged to direct light through the navigation device to be visible by a user.

16. The apparatus of claim 15 wherein the backlight is selectively energized to selectively indicate whether the navigation device is active.

17. The apparatus of claim 12 wherein the navigation device comprises a trackball, wherein the trackball is arranged to operate so as navigate a designator through the game related options, and wherein the trackball is arranged to operate as a control input device.

18. The apparatus of claim 12 further comprising a processor responsive to the navigation device and the switch.

19. The apparatus of claim 18 wherein the processor is arranged to variably display images on the variable display.

20. The apparatus of claim 18 wherein the navigation device comprises a trackball, and wherein the processor is arranged to decode position data from the trackball.

21. The apparatus of claim 18 wherein the processor includes a communication port permitting the processor to communicate with another processor.
